(19) United States
(12) Patent Application Publication
(10) Pub. No.: US 2018/0266365 A1
(43) Pub. Date: Sep. 20, 2018

(54) EXHAUST GAS CONTROL APPARATUS OF INTERNAL COMBUSTION ENGINE

(71) Applicant: TOYOTA JIDOSHA KABUSHIKI KAISHA, Toyota-shi (JP)

(72) Inventor: Shinsuke AOYAGI, Isehara-shi (JP)

(73) Assignee: TOYOTA JIDOSHA KABUSHIKI KAISHA, Toyota-shi (JP)

(21) Appl. No.: 15/918,545

(22) Filed: Mar. 12, 2018

(30) Foreign Application Priority Data
Mar. 14, 2017 (JP) 2017-048519

(51) Int. Cl. F02M 26/07; F02M 26/23; F02M 26/40; F02M 26/41

(52) U.S. Cl. CPC F02M 26/07; F02M 26/23; F02M 2026/004; F02M 26/41; F02M 26/40

(57) ABSTRACT

An exhaust gas control apparatus of an internal combustion engine includes a turbocharger including a turbine in an exhaust passage of the internal combustion engine, a post-processing device configured to control exhaust gas, the post-processing device being disposed in the exhaust passage downstream of the turbine, an EGR passage configured to connect the exhaust passage downstream of the turbine and upstream of the post-processing device with a cylinder of the internal combustion engine, and an EGR device including an EGR valve which is disposed in an end portion on the cylinder side of the EGR passage and opens or closes the EGR passage in the cylinder.

### INCORPORATION BY REFERENCE

The disclosure of Japanese Patent Application No. 2017-048519 filed on Mar. 14, 2017 including the specification, drawings and abstract is incorporated herein by reference in its entirety.

### BACKGROUND

### 1. Technical Field

The present disclosure relates to an exhaust gas control apparatus of an internal combustion engine.

### 2. Description of Related Art

In a known technology (refer to, for example, Japanese Unexamined Patent Application Publication No. 2000-073875 (JP 2000-073875 A)), an exhaust gas recirculation (EGR) valve is disposed in a cylinder in order to directly recirculate exhaust gas in an exhaust manifold into the cylinder.

### SUMMARY

When EGR gas is drawn from the upstream side of a turbine of a turbocharger, the amount of exhaust gas passing through the turbine is decreased by the amount of drawn EGR gas. Accordingly, when the amount of EGR gas is increased, the boost pressure may be decreased. With the configuration in the related art, it is difficult to establish both of an increase in the amount of EGR gas and an increase in boost pressure. The same applies to a high pressure EGR device including an EGR passage that connects an exhaust passage on the upstream side of a turbine with an intake passage on the downstream side of a compressor.

The present disclosure provides an exhaust gas control apparatus of an internal combustion engine that suitably supplies EGR gas while a decrease in boost pressure is suppressed.

An aspect of the present disclosure relates to an exhaust gas control apparatus of an internal combustion engine. The exhaust gas control apparatus includes a turbocharger, a post-processing device, an EGR passage, and an EGR device. The turbocharger includes a turbine in an exhaust passage of the internal combustion engine. The post-processing device is configured to control exhaust gas, and is disposed in the exhaust passage downstream of the turbine. The EGR passage is configured to connect the exhaust passage downstream of the turbine and upstream of the post-processing device with a cylinder of the internal combustion engine. The EGR device includes an EGR valve which is disposed in an end portion on the cylinder side of the EGR passage and opens or closes the EGR passage in the cylinder.

In the EGR device according to the aspect, the EGR valve is opened or closed in the cylinder. Thus, when the opening degree of the EGR valve is changed, the amount of EGR gas is immediately changed. That is, high responsiveness is achieved when the amount of EGR gas is controlled. Fresh air and EGR gas are mixed with each other in the cylinder. Thus, condensed water is unlikely to be generated. That is, fresh air receives heat from an intake passage while the fresh air is introduced into the cylinder, and the temperature of fresh air is comparatively increased. Thus, even when fresh air and EGR gas are mixed with each other in the cylinder, the temperature of mixed gas is unlikely to be decreased to or below the dew point. When EGR gas is supplied, the opening degree of an intake throttle valve or an exhaust throttle valve does not need to be decreased. Thus, pumping loss can be decreased. EGR gas is drawn from the downstream side of the turbine. Thus, even when EGR gas is supplied, the amount of exhaust gas passing through the turbine is not decreased. Accordingly, it is possible to supply EGR gas while a decrease in boost pressure is suppressed. EGR gas is drawn from the upstream side of the post-processing device. Thus, the amount of exhaust gas flowing into the post-processing device can be decreased by drawing EGR gas. Accordingly, exhaust gas can be suitably controlled in the post-processing device. The post-processing device can be exemplified by a catalyst or a particulate filter.

The exhaust gas control apparatus according to the aspect of the present disclosure may further include an adjusting mechanism configured to adjust an opening and closing timing of the EGR valve, and a control device configured to control the adjusting mechanism. When the temperature in the cylinder of the internal combustion engine is lower than a target temperature, the control device may control the adjusting mechanism such that a valve opening start timing of the EGR valve occurs in an exhaust stroke, and that a valve closing completion timing of the EGR valve occurs in an intake stroke.

For example, the target temperature is the temperature in the cylinder at which the level of deterioration of emission falls within an allowable range. The temperature in the cylinder is the temperature of gas including fresh air and EGR gas in the cylinder. The temperature in the cylinder may be the temperature of gas at a predetermined crank angle at which fresh air and EGR gas are mixed with each other. When the temperature in the cylinder is low at the start or the like of the internal combustion engine, the state of combustion is likely to deteriorate. Increasing the temperature in the cylinder can suppress deterioration of the state of combustion. Therefore, the valve opening start timing of the EGR valve is adjusted such that the EGR valve starts to open in the exhaust stroke. Accordingly, the EGR valve is opened when the pressure in the cylinder is higher than the pressure in the EGR passage, and burned gas flows toward the EGR passage from the cylinder. In the intake stroke, the pressure in the cylinder is decreased when a piston moves down. Thus, by adjusting the valve closing completion timing of the EGR valve such that the EGR valve is fully closed in the intake stroke, burned gas that flows to the EGR passage from the cylinder in the exhaust stroke returns to the cylinder from the EGR passage in the intake stroke. When merely EGR gas that is introduced to the EGR passage from the exhaust passage is supplied, EGR gas loses heat to burned gas in the exhaust passage and the EGR passage, and the temperature of EGR gas is comparatively decreased. When burned gas that flows to the EGR passage from the cylinder is supplied as EGR gas, the amount of heat lost from EGR gas can be decreased, and EGR gas having a comparatively high temperature can be supplied into the cylinder. Thus, the temperature in the cylinder can be increased. When the temperature in the cylinder is higher than or equal to the target temperature, the amount of burned gas that flows to the EGR passage from the cylinder can be decreased by setting the valve opening start timing of the EGR valve to be in, for example, the intake stroke. Thus, an excessive increase in the temperature in the cylinder can be suppressed.

In the exhaust gas control apparatus according to the aspect of the present disclosure, when the temperature in the cylinder of the internal combustion engine is lower than the target temperature, the control device may control the adjusting mechanism such that the valve opening start timing of the EGR valve is before an exhaust top dead center, and that the valve closing completion timing of the EGR valve is after the exhaust top dead center.

In the exhaust gas control apparatus according to the aspect of the present disclosure, the EGR device may further include, in the EGR passage, a non-return valve that allows gas to flow to the cylinder side from the exhaust passage side and does not allow gas to flow to the exhaust passage side from the cylinder side.

The non-return valve can restrict the amount of burned gas or fresh air that flows into the EGR passage from the cylinder. Accordingly, it is possible to suppress a decrease in the concentration of EGR gas due to fresh air that flows into the EGR passage from the cylinder. It is possible to suppress an excessive increase in the temperature of EGR gas due to high temperature burned gas that flows into the EGR passage from the cylinder.

In the exhaust gas control apparatus according to the aspect of the present disclosure, the EGR device may further include, in the EGR passage, a non-return valve that allows gas to flow to the cylinder side from the exhaust passage side and does not allow gas to flow to the exhaust passage side from the cylinder side. The non-return valve may be provided in a position where a capacity of the EGR passage from the EGR valve to the non-return valve is greater than or equal to a capacity corresponding to an amount of gas that flows to the EGR passage from the cylinder when the EGR valve is open in the exhaust stroke.

When burned gas flows to the EGR passage from the cylinder in the exhaust stroke in order to increase the temperature of EGR gas, an amount of burned gas needed for the temperature adjustment needs to flow to the EGR passage from the cylinder. The temperature of EGR gas can be adjusted by disposing the non-return valve in a position where an amount of burned gas needed for the temperature adjustment flows to the EGR passage from the cylinder. That is, the temperature of EGR gas can be adjusted by disposing the non-return valve in a position where the capacity of the EGR passage from the EGR valve to the non-return valve is greater than or equal to the capacity corresponding to the amount of gas that flows to the EGR passage from the cylinder when the EGR valve is open in the exhaust stroke. By disposing the non-return valve, it is possible to suppress an amount of burned gas flowing to the EGR passage from the cylinder more than needed.

In the exhaust gas control apparatus according to the aspect of the present disclosure, the EGR device further may include an EGR cooler configured to cool gas, and the EGR cooler is provided in the EGR passage between the exhaust passage and the non-return valve.

Accordingly, EGR gas passes through the non-return valve after the temperature of EGR gas is decreased by the EGR cooler, and an increase in the temperature of the non-return valve can be suppressed. Accordingly, deterioration of the non-return valve can be suppressed.

In the exhaust gas control apparatus according to the aspect of the present disclosure, the EGR device further may include an EGR cooler configured to cool gas, and the EGR cooler is provided in the EGR passage between the cylinder and the non-return valve.

In the exhaust gas control apparatus according to the aspect of the present disclosure, the EGR device may further include an EGR cooler that cools gas in the EGR passage.

Accordingly, gas can be introduced into the cylinder after the temperature of gas is decreased by the EGR cooler.

According to the aspect of the present disclosure, it is possible to suitably supply EGR gas while a decrease in boost pressure is suppressed.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating a schematic configuration of an internal combustion engine according to a first embodiment;

FIG. 2 is a graph illustrating a relationship between a lift amount and a crank angle in each of an intake valve, an exhaust valve, and an EGR valve;

FIG. 3 is a graph illustrating the relationship between the lift amount and the crank angle in each of the intake valve, the exhaust valve, and the EGR valve when the amount of EGR gas is adjusted by changing the opening and closing timing of the intake valve;

FIG. 4 is a graph illustrating the relationship between the lift amount and the crank angle in each of the intake valve, the exhaust valve, and the EGR valve when the temperature of EGR gas is adjusted by changing the opening and closing timing of the EGR valve;

FIG. 5 is a flowchart illustrating a flow of controlling the temperature of EGR gas according to a second embodiment; and

FIG. 6 is a diagram illustrating a schematic configuration of an internal combustion engine according to a third embodiment.

### DETAILED DESCRIPTION OF EMBODIMENTS

Hereinafter, embodiments will be illustratively described in detail with reference to the drawings. The dimension, material, shape, relative arrangement, and the like of each constituent disclosed in the embodiments are not intended to limit the scope of the present disclosure to the disclosure of the embodiments unless otherwise specified.

### First Embodiment

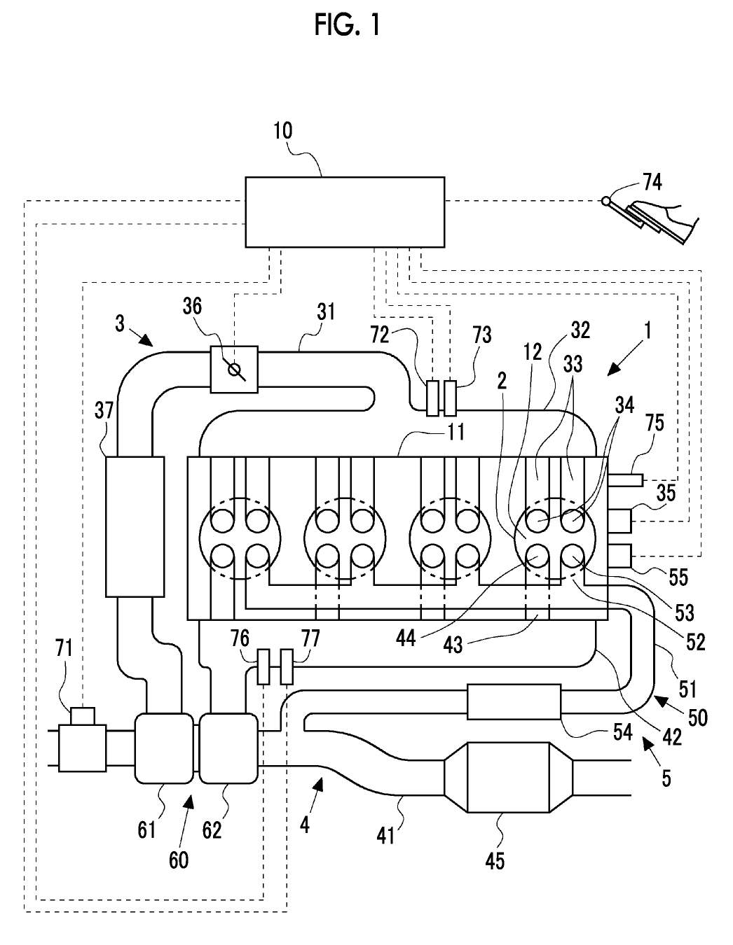

FIG. 1 is a diagram illustrating a schematic configuration of an internal combustion engine 1 according to a first embodiment. In the first embodiment, a part of constituents of the internal combustion engine 1 is not illustrated for simple illustration of the internal combustion engine 1. For example, the internal combustion engine 1 is mounted in a vehicle. The internal combustion engine 1 has four cylinders 2. The number of cylinders 2 of the internal combustion engine 1 is not limited to four.

An intake manifold 32 and an exhaust manifold 42 are connected to a cylinder head 11 of the internal combustion engine 1. The intake manifold 32 is a part of an intake pipe 31. The exhaust manifold 42 is a part of an exhaust pipe 41. An intake port 33 that is connected to each cylinder 2 from the intake manifold 32, and an exhaust port 43 that is connected to each cylinder 2 from the exhaust manifold 42 are formed in the cylinder head 11. An intake valve 34 is included in the cylinder 2 side end portion of the intake port 33. An exhaust valve 44 is included in the cylinder 2 side end portion of the exhaust port 43. All of the intake pipe 31, the intake manifold 32, and the intake port 33 are included in an intake passage 3. All of the exhaust pipe 41, the exhaust manifold 42, and the exhaust port 43 are included in an exhaust passage 4.

An EGR device 5 is included in the internal combustion engine 1. The EGR device 5 includes an EGR pipe 51, an EGR port 52, an EGR valve 53, and an EGR cooler 54. The EGR pipe 51 is connected to the cylinder head 11. The EGR port 52 that is connected to each cylinder 2 from the EGR pipe 51 is formed in the cylinder head 11. A first end of the EGR port 52 is connected to the EGR pipe 51, and a second end of the EGR port 52 branches into four that are respectively connected to the cylinders 2. The EGR valve 53 is included in the cylinder 2 side end portion of the EGR port 52. Accordingly, the EGR valve 53 opens or closes the EGR port 52 in each cylinder 2. The EGR cooler 54 that exchanges heat between EGR gas and outside air or a coolant in the internal combustion engine 1 is disposed in the middle of the EGR pipe 51. The EGR cooler 54 may not be needed in the first embodiment. The EGR pipe 51 and the EGR port 52 are included in an EGR passage 50.

A mechanism (hereinafter, referred to as an intake valve gear) 35 that changes the phase of the intake valve 34 is disposed in the first embodiment. A mechanism (hereinafter, referred to as an EGR valve gear) 55 that changes at least one of the phase and the lift amount of the EGR valve 53 is disposed in the first embodiment. The intake valve gear 35 and the EGR valve gear 55 can use the structure of a well-known variable valve gear. A piston 12 is disposed in each cylinder 2. The EGR valve gear 55 in the first embodiment is one example of an adjusting mechanism in the present disclosure.

A compressor 61 of a turbocharger 60 that is operated with the energy of exhaust gas as a drive source is disposed in the middle of the intake pipe 31. A throttle 36 that adjusts the amount of intake air flowing through the intake pipe 31 is included in the intake pipe 31 downstream of the compressor 61 and upstream of the intake manifold 32. An intercooler 37 that exchanges heat between intake air and outside air or the coolant in the internal combustion engine 1 is disposed in the intake pipe 31 downstream of the compressor 61 and upstream of the throttle 36. The turbocharger 60 in the first embodiment is one example of a turbocharger in the present disclosure.

An air flow meter 71 that outputs a signal corresponding to the amount of air flowing through the intake pipe 31 is attached to the intake pipe 31 upstream of the compressor 61. The air flow meter 71 detects the amount of fresh air in the internal combustion engine 1. An intake pressure sensor 72 that outputs a signal corresponding to the pressure in the intake manifold 32, and an intake temperature sensor 73 that outputs a signal corresponding to the temperature in the intake manifold 32 are attached to the intake manifold 32.

A turbine 62 of the turbocharger 60 is disposed in the middle of the exhaust pipe 41 downstream of the exhaust manifold 42. An exhaust gas control catalyst 45 is disposed in the exhaust pipe 41 downstream of the turbine 62. The exhaust gas control catalyst 45 can be exemplified by an oxidation catalyst, a three-way catalyst, an adsorptive reduction NOx catalyst, a selective reduction NOx catalyst, or the like. A filter that captures PM in exhaust gas may be disposed instead of the exhaust gas control catalyst 45. Alternatively, the exhaust gas control catalyst 45 may be included in the filter. The exhaust gas control catalyst 45 in the first embodiment is one example of a post-processing device in the present disclosure. An exhaust pressure sensor 76 that outputs a signal corresponding to the pressure in the exhaust manifold 42, and an exhaust temperature sensor 77 that outputs a signal corresponding to the temperature in the exhaust manifold 42 are attached to the exhaust manifold 42.

The EGR pipe 51 according to the first embodiment is connected to the exhaust pipe 41 downstream of the turbine 62 and upstream of the exhaust gas control catalyst 45. The EGR pipe 51 draws exhaust gas as EGR gas from the position of the connection.

While two intake valves 34, one exhaust valve 44, and one EGR valve 53 are disposed in the first embodiment, the numbers of intake valves, exhaust valves, and EGR valves are not limited thereto. For example, one intake valve 34, two exhaust valves 44, and one EGR valve 53 may be disposed. Alternatively, two intake valves 34, two exhaust valves 44, and one EGR valve 53 may be disposed. Alternatively, one intake valve 34, one exhaust valve 44, and one EGR valve 53 may be disposed.

An ECU 10 that is an electronic control device for controlling the internal combustion engine 1 is disposed along with the internal combustion engine 1. The ECU 10 includes a CPU and a ROM, a RAM, and the like storing various programs and maps. The ECU 10 controls the internal combustion engine 1 in accordance with the operating condition of the internal combustion engine 1 or a request from a driver.

In addition to the various sensors, an accelerator operation amount sensor 74 and a crank position sensor 75 are electrically connected to the ECU 10. The ECU 10 receives a signal corresponding to the accelerator operation amount from the accelerator operation amount sensor 74, and calculates an engine load and the like needed for the internal combustion engine 1 in accordance with the signal. The ECU 10 receives a signal corresponding to the rotation angle of the output shaft of the internal combustion engine 1 from the crank position sensor 75, and calculates the engine rotation speed of the internal combustion engine 1. The intake valve gear 35 and the EGR valve gear 55 are connected to the ECU 10 through electrical wiring and are controlled by the ECU 10.

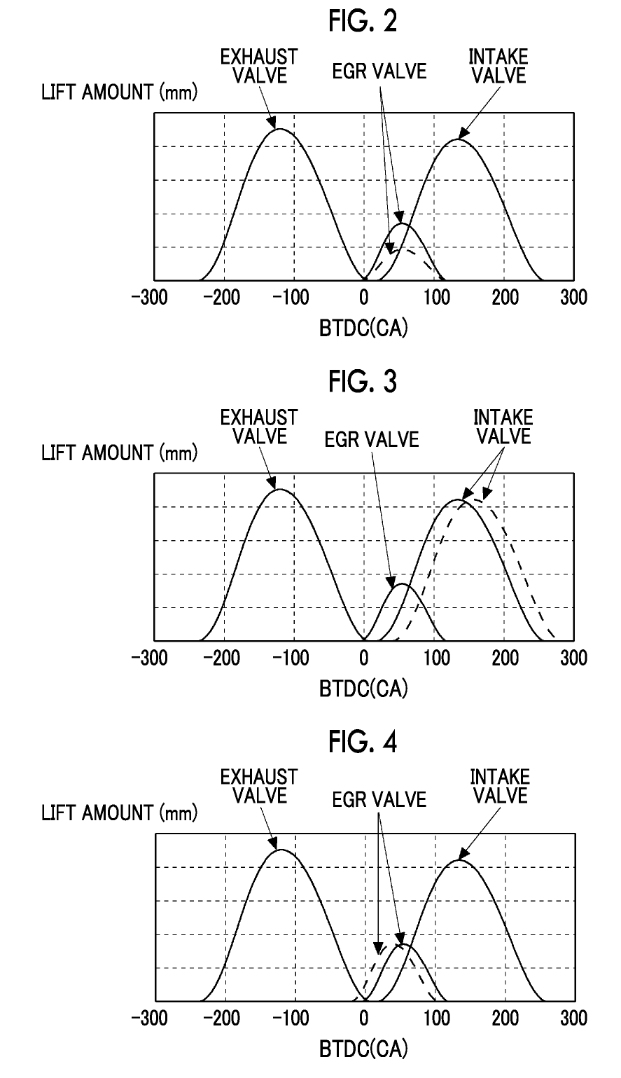

For example, the ECU 10 adjusts the amount of EGR gas as follows. FIG. 2 is a graph illustrating the relationship between the lift amount and the crank angle in each of the intake valve 34, the exhaust valve 44, and the EGR valve 53. The horizontal axis denotes the crank angle after the exhaust top dead center (BTDC) with the exhaust top dead center as a reference (that is, zero). In FIG. 2, a solid line is an illustration of when the lift amount is comparatively increased in the EGR valve 53. A broken line is an illustration of when the lift amount is comparatively decreased in the EGR valve 53. As illustrated in FIG. 2, the amount of EGR gas supplied into the cylinder 2 can be adjusted by changing the lift amount of the EGR valve 53. For example, the amount of EGR gas becomes equal to zero by setting the lift amount of the EGR valve 53 to 0 mm. As the lift amount of the EGR valve 53 is increased, the amount of EGR gas can be increased.

In the example illustrated in FIG. 2, the EGR valve 53 starts to open when the piston 12 is in the vicinity of the exhaust top dead center. Then, the intake valve 34 starts to open after a predetermined interval. The predetermined interval is acquired in advance by experiment, simulation, or the like. Hereinafter, a timing at which the intake valve 34 or the EGR valve 53 starts to open will be referred to as a “valve opening start timing”. Hereinafter, a timing at which the intake valve 34 or the EGR valve 53 is completely closed (that is, the timing of full closure) will be referred to as a “valve closing completion timing”. The valve opening start timing of the intake valve 34 is not limited to the timing illustrated in FIG. 2. For example, the valve opening start timing of the intake valve 34 may be set to be after the valve closing completion timing of the EGR valve 53. Accordingly, while the EGR valve 53 is open, intake air is not introduced into the cylinder even when the pressure of intake air is high due to a boost. Thus, it is possible to suppress intake air flowing out to the EGR port 52 from the cylinder 2. While the predetermined interval is disposed between the valve opening start timing of the EGR valve 53 and the valve opening start timing of the intake valve 34 in FIG. 2, the present disclosure is not limited thereto. For example, the valve opening start timings of the EGR valve 53 and the intake valve 34 may be approximately the same. In the example illustrated in FIG. 2, the lift amount of the EGR valve 53 is changed, but the valve opening start timing and the valve closing completion timing of the EGR valve 53 are not changed. Instead, the valve opening start timing or the valve closing completion timing of the EGR valve 53 may be changed in the first embodiment. For example, as the lift amount of the EGR valve 53 is decreased, the valve closing completion timing of the EGR valve 53 may be advanced without changing the valve opening start timing of the EGR valve 53.

A target amount of EGR gas and the lift amount of the EGR valve 53 for achieving the target amount of EGR gas can be acquired by the following functions.

Target amount of EGR gas=F1 (engine rotation speed, amount of fuel injection, amount of fresh air, pressure and temperature of gas in intake manifold, temperature of outside air, pressure of outside air, temperature of coolant, and humidity of outside air)

Lift amount of EGR valve 53=F2 (target amount of EGR gas, pressure and temperature of gas in exhaust manifold, and pressure and temperature of gas in EGR port 52 or EGR pipe 51)

The relationships may be acquired and mapped in advance by experiment, simulation, or the like.

The amount of EGR gas can be adjusted by changing the opening and closing timing of the EGR valve 53 or the opening and closing timing of the intake valve 34 without changing the lift amount of the EGR valve 53. FIG. 3 is a graph illustrating the relationship between the lift amount and the crank angle in each of the intake valve 34, the exhaust valve 44, and the EGR valve 53 when the amount of EGR gas is adjusted by changing the opening and closing timing of the intake valve 34. In FIG. 3 as well, the horizontal axis denotes the crank angle after the exhaust top dead center (BTDC) with the exhaust top dead center as a reference, in the same manner as FIG. 2. FIG. 3 is an illustration of when the opening and closing timing of the intake valve 34 is advanced or retarded. In FIG. 3, a solid line is an illustration of when the opening and closing timing of the intake valve 34 is comparatively advanced. A broken line is an illustration of when the opening and closing timing of the intake valve 34 is comparatively retarded. When the opening and closing timing of the intake valve 34 is advanced or retarded, the intake valve gear 35 is controlled to achieve the same amount of advance or retard at the valve opening start timing and the valve closing completion timing of the intake valve 34.

As illustrated in FIG. 3, the ECU 10 adjusts the amount of EGR gas supplied into the cylinder 2 by advancing or retarding the opening and closing timing of the intake valve 34 with respect to the opening and closing timing of the EGR valve 53. For example, a period in which the EGR valve 53 and the intake valve 34 are open at the same time during an intake stroke is extended by advancing the opening and closing timing of the intake valve 34. Accordingly, a period in which fresh air and EGR gas are taken in at the same time is extended. When fresh air and EGR gas are taken in at the same time, the amount of intake EGR gas is smaller by the amount of intake air than when merely EGR gas is taken in with the intake valve 34 closed. Accordingly, as the period in which the EGR valve 53 and the intake valve 34 are open at the same time is extended, the amount of EGR gas is decreased. That is, as the opening and closing timing of the intake valve 34 is advanced, or as the opening and closing timing of the EGR valve 53 is retarded, the amount of EGR gas is decreased. The relationship between the amount of EGR gas and the opening and closing timing of each of the intake valve 34 and the EGR valve 53 may be acquired and mapped in advance by experiment, simulation, or the like.

The amount of EGR gas may also be adjusted by adjusting the lift amount of the EGR valve 53 in combination with adjusting the opening and closing timing of each of the EGR valve 53 and the intake valve 34. In such a case, the lift amount of the EGR valve 53 and the relationship between the amount of EGR gas and the opening and closing timing of each of the EGR valve 53 and the intake valve 34 may be acquired and mapped in advance by experiment, simulation, or the like.

A high pressure EGR device in the related art includes an EGR passage that connects an exhaust passage upstream of a turbine with an intake passage downstream of a throttle. Thus, when EGR gas is drawn from the exhaust passage, the amount of exhaust gas passing through the turbine is decreased. Accordingly, it may be difficult to increase the boost pressure when supplying EGR gas. When the EGR passage is connected upstream of the turbine, the capacity of the exhaust passage on the upstream side of the turbine is increased. Thus, the exhaust pulsation is attenuated, and the performance of the turbine may be decreased. Accordingly, it may be difficult to increase the boost pressure.

In the EGR device 5 according to the first embodiment, exhaust gas is drawn as EGR gas after passing through the turbine 62. Thus, it is possible to suppress a decrease in the amount of exhaust gas passing through the turbine 62. It is also possible to suppress an increase in the capacity of the exhaust passage before the turbine 62. Accordingly, the boost pressure can be increased even when EGR gas is supplied.

In the high pressure EGR device in the related art, when the pressure on the intake passage side of the EGR passage becomes higher than the pressure on the exhaust passage side of the EGR passage due to a boost, fresh air flows back through the EGR passage, and it is difficult to supply EGR gas.

In the EGR device 5 according to the first embodiment, even when the boost pressure is high, EGR gas can be supplied into the cylinder 2 by adjusting the opening and closing timing of each of the EGR valve 53 and the intake valve 34. For example, by opening and closing the EGR valve 53 in the first half of the intake stroke to introduce EGR gas into the cylinder 2 in the intake stroke, and closing the EGR valve 53 and opening the intake valve 34, it is possible to suppress fresh air flowing back through the EGR passage 50 even when the boost pressure is high. That is, while the EGR valve 53 is open, a negative pressure is caused in the cylinder 2 when the piston 12 moves down. However, the pressure in the exhaust pipe 41 downstream of the turbine 62 is approximately equal to atmospheric pressure, and the pressure in the cylinder 2 becomes lower than the pressure in the EGR passage 50. Thus, EGR gas is supplied into the cylinder 2 through the EGR passage 50. When the valve opening start timing of the intake valve 34 is after the valve closing completion timing of the EGR valve 53, intake air does not flow to the EGR passage 50 even when high pressure intake air is introduced to the cylinder 2 by opening the intake valve 34.

A low pressure EGR device in the related art includes an EGR passage that connects an exhaust passage downstream of an exhaust gas control catalyst with an intake passage upstream of a compressor. In such a case, exhaust gas is drawn as EGR gas after passing through the exhaust gas control catalyst, and the amount of exhaust passing through the exhaust gas control catalyst is comparatively decreased. When an amount of exhaust gas more than allowed in the exhaust gas control catalyst flows into the exhaust gas control catalyst, exhaust gas is not completely controlled. Thus, the size of the exhaust gas control catalyst needs to be increased in the related art.

In the EGR device 5 according to the first embodiment, the EGR pipe 51 is connected to the exhaust pipe 41 upstream of the exhaust gas control catalyst 45. Thus, exhaust gas can be drawn as EGR gas before passing through the exhaust gas control catalyst 45, and the amount of exhaust gas passing through the exhaust gas control catalyst 45 is decreased by the drawn amount of EGR gas. Accordingly, the exhaust gas control efficiency of the exhaust gas control catalyst 45 is increased. When the exhaust gas control efficiency is increased, the size of the exhaust gas control catalyst 45 can be decreased.

The high pressure EGR device and the low pressure EGR device in the related art have a comparatively long distance from the EGR valve to the cylinder. Thus, even when the opening degree of the EGR valve is adjusted, it takes time to actually change the amount of EGR gas in the cylinder 2. That is, response is delayed. Thus, it takes time to set the amount of EGR gas to the target value.

In the EGR device 5 according to the first embodiment, the EGR valve 53 is opened and closed in the cylinder 2. Thus, the amount of EGR gas in the cylinder 2 can be immediately adjusted by adjusting the opening and closing timing of the EGR valve 53. That is, there is almost no delay in response. When EGR gas is not needed, it is possible to immediately stop supplying EGR gas by opening the EGR valve 53.

In the high pressure EGR device and the low pressure EGR device in the related art, EGR gas having a high temperature and high humidity is mixed with fresh air having a low temperature in the intake passage, and condensed water may be generated. Condensed water may corrode members included in the intake passage, or condensed water on the cylinder wall may be mixed with lubricating oil. The temperature of fresh air can be adjusted to suppress generation of condensed water. However, in such a case, the temperature of fresh air is increased, and output may be decreased, or fuel consumption may deteriorate. When the temperature of outside air is excessively low, it is difficult to supply EGR gas since condensed water may be generated.

In the EGR device 5 according to the first embodiment, fresh air and EGR gas are mixed with each other in the cylinder 2. While fresh air is being mixed with EGR gas, fresh air receives heat from burned gas or the like remaining in the intake pipe 31, the intake port 33, the intake valve 34, and the cylinder 2. Accordingly, when fresh air is mixed with EGR gas, the temperature of fresh air is increased to a certain extent. Thus, even when fresh air and EGR gas are mixed with each other in the cylinder 2, the temperature of mixed gas may be increased above the dew point, and condensed water is unlikely to be generated.

In the high pressure EGR device and the low pressure EGR device in the related art, when a large amount of EGR gas is supplied, it is needed to either decrease the pressure of intake air on the downstream side of an intake throttle valve by closing the intake throttle valve, or increase the pressure of exhaust gas on the upstream side of an exhaust throttle valve by closing the exhaust throttle valve, in order to increase the difference in pressure between the exhaust passage side and the intake passage side. When a variable-geometry turbocharger having a nozzle vane is included, a large amount of EGR gas may be supplied by closing the nozzle vane to increase the pressure of exhaust gas upstream of the turbocharger. Thus, when a large amount of EGR gas is supplied, pumping loss is increased, and fuel consumption deteriorates.

In the EGR device 5 according to the first embodiment, the amount of EGR gas supplied into the cylinder 2 can be adjusted by adjusting the opening and closing timing of the intake valve 34 and the opening and closing timing of the EGR valve 53, and it is not needed to close the intake throttle valve or the exhaust throttle valve, or close the nozzle vane. Thus, pumping loss is not increased. Therefore, deterioration of fuel consumption may be suppressed.

According to the first embodiment described heretofore, it is possible to suitably supply EGR gas while a decrease in boost pressure is suppressed.

### Second Embodiment

In a second embodiment, the temperature of EGR gas is adjusted by adjusting the opening and closing timing of the EGR valve 53. Other devices and the like are the same as the first embodiment and thus, will not be described.

When the temperature in the cylinder 2 is low at the start or the like of the internal combustion engine 1, the state of combustion is likely to deteriorate. Increasing the temperature in the cylinder 2 can suppress deterioration of the state of combustion. Therefore, when the temperature in the cylinder 2 is lower than a target temperature, the ECU 10 according to the second embodiment adjusts the valve opening start timing of the

EGR valve 53 to set the temperature in the cylinder 2 to be higher than or equal to the target temperature.

FIG. 4 is a graph illustrating the relationship between the lift amount and the crank angle in each of the intake valve 34, the exhaust valve 44, and the EGR valve 53 when the temperature of EGR gas is adjusted by changing the opening and closing timing of the EGR valve 53. The horizontal axis denotes the crank angle after the exhaust top dead center (BTDC) with the exhaust top dead center as a reference. In FIG. 4, a solid line is an illustration of when the valve opening start timing of the EGR valve 53 is set to be after the exhaust top dead center. A broken line is an illustration of when the valve opening start timing of the EGR valve 53 is set to be before the exhaust top dead center. When the opening and closing timing of the EGR valve 53 is advanced or retarded, the EGR valve gear 55 is controlled to achieve the same amount of advance or retard at the valve opening start timing and the valve closing completion timing of the EGR valve 53. In the second embodiment, the temperature of EGR gas is adjusted by advancing the valve opening start timing of the EGR valve 53 to be before the exhaust top dead center. In the second embodiment, the temperature of EGR gas and the amount of EGR gas may be adjusted at the same time by adjusting the lift amount of the EGR valve 53 in combination with adjusting the opening and closing timing of the intake valve 34 as described in the first embodiment. As illustrated in FIG. 4, in the second embodiment, the valve closing completion timing of the EGR valve 53 is set such that the valve closing completion timing of the EGR valve 53 occurs during the intake stroke. In the second embodiment, when the valve opening start timing of the EGR valve 53 is changed, the valve opening start timing of the intake valve 34 may also be changed.

In an exhaust stroke, burned gas in the cylinder 2 in the exhaust stroke is pressed by the piston 12, and the pressure in the cylinder 2 becomes higher than the pressure in the EGR port 52. Thus, when the valve opening start timing of the EGR valve 53 is adjusted such that the valve opening start timing of the EGR valve 53 occurs during the exhaust stroke, high temperature burned gas flows to the EGR port 52 from the cylinder 2 in the exhaust stroke. In the intake stroke after the exhaust top dead center, the pressure in the cylinder 2 is decreased when the piston 12 moves down. Accordingly, the pressure in the cylinder 2 becomes higher than the pressure in the EGR port 52, and high temperature burned gas in the EGR port 52 returns to the cylinder 2 as EGR gas. Furthermore, the intake valve 34 is opened, and fresh air is introduced into the cylinder 2. Accordingly, high temperature internal EGR gas can be supplied into the cylinder 2.

Even after burned gas that flows out to the EGR port 52 from the cylinder 2 completely returns to the cylinder 2, when the EGR valve 53 is open, external EGR gas that is EGR gas having a low temperature after passing through the EGR cooler 54 is supplied into the cylinder 2. Accordingly, when both of the internal EGR gas and the external EGR gas are supplied by setting the valve opening start timing of the EGR valve 53 to be before the exhaust top dead center, the temperature of EGR gas is increased further than when the external EGR gas is supplied by setting the valve opening start timing of the EGR valve 53 to be after the exhaust top dead center. Thus, the temperature in the cylinder 2 after EGR gas and fresh air are mixed with each other is also increased. The amount of internal EGR gas and the amount of external EGR gas can be adjusted by adjusting the valve opening start timing of the EGR valve 53. Thus, the temperature of EGR gas and the temperature in the cylinder 2 can be adjusted.

When the high pressure EGR device or the low pressure EGR device in the related art includes a bypass passage that detours an EGR cooler, the temperature of EGR gas can be increased by causing EGR gas to detour through the bypass passage. However, disposing the bypass passage increases the cost. Even when EGR gas flows through the bypass passage, heat is released from EGR gas in the bypass passage or the EGR passage, and the temperature of EGR gas is decreased. Thus, the temperature of EGR gas is adjusted in a narrow range. In the EGR device 5 according to the second embodiment, the temperature of EGR gas can be increased by introducing, as the internal EGR gas, high temperature burned gas that flows back to the EGR port 52. Thus, the temperature of EGR gas is adjusted in a wide range.

When both of the internal EGR gas and the external EGR gas are supplied into the cylinder 2, the ECU 10 sets the opening and closing timing of the EGR valve 53 such that the valve opening start timing of the EGR valve 53 occurs during the exhaust stroke, and that the valve closing completion timing of the EGR valve 53 occurs during the intake stroke, and controls the EGR valve gear 55 to achieve the opening and closing timing. The EGR valve gear 55 may be controlled such that the amount of advance of the valve opening start timing of the EGR valve 53 from the exhaust top dead center is increased as the difference between the target temperature and the temperature in the cylinder 2 is increased.

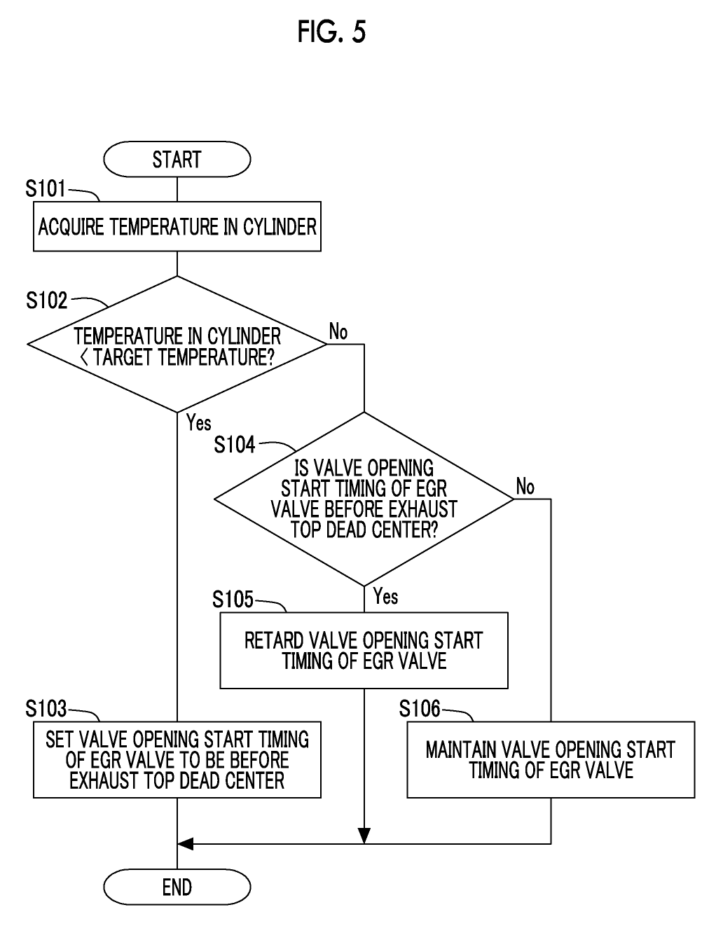

FIG. 5 is a flowchart illustrating a flow of controlling the temperature of EGR gas according to the second embodiment. The flowchart in FIG. 5 is executed per predetermined time period (or predetermined cycle) by the ECU 10. The flowchart in FIG. 5 may be performed at the time of low load operation or the start of the internal combustion engine 1 at which the temperature in the cylinder 2 may be low.

In step S101, the temperature in the cylinder 2 is acquired. The temperature in the cylinder 2 is the temperature of gas including fresh air and EGR gas in the cylinder 2. The temperature in the cylinder 2 may be a temperature at a predetermined crank angle. The predetermined crank angle is the crank angle at which the amount of gas in the cylinder 2 is not changed. For example, the predetermined crank angle is the crank angle during a compression stroke. That is, since the temperature in the cylinder 2 may be changed when gas flows into the cylinder 2 or flows out from the cylinder 2, a temperature at which gas does not flow in or out may be used. For example, the temperature in the cylinder 2 may be a temperature at the intake bottom dead center, the compression top dead center, the ignition timing, or the firing timing. The temperature in the cylinder 2 may be detected by disposing a temperature sensor in the cylinder 2, or may be estimated by the ECU 10 based on the operating state of the internal combustion engine 1. The estimation can be performed using a well-known technology. Even when the temperature in the cylinder 2 is low, EGR gas cannot be supplied during the current cycle of the compression stroke, and the temperature in the cylinder 2 cannot be increased. Accordingly, the temperature in the cylinder 2 is equal to the temperature in the cylinder 2 in the previous cycle or the second previous cycle. The temperature in the cylinder 2 may be predicted from the operating state or the like of the internal combustion engine 1. The prediction can be performed using a well-known technology. For example, the target temperature is the temperature in the cylinder 2 at which the level of deterioration of emission falls within an allowable range, and is acquired in advance by experiment, simulation, or the like.

In step S102, a determination as to whether or not the temperature in the cylinder 2 is lower than the target temperature is performed. In step S102, a determination as to whether or not the temperature of EGR gas needs to be increased is performed. When a positive determination is made in step S102, a transition is made to step S103. When a negative determination is made in step S102, a transition is made to step S104.

In step S103, the valve opening start timing of the EGR valve 53 is set to be before the exhaust top dead center. That is, the temperature of EGR gas is increased in order to set the temperature in the cylinder 2 to be higher than or equal to the target temperature. The valve closing completion timing of the EGR valve 53 is set to be after the exhaust top dead center. As the difference between the target temperature and the temperature in the cylinder 2 acquired in step S101 is increased, the valve opening start timing of the EGR valve 53 may be advanced, or the valve opening start timing of the EGR valve 53 may be advanced by the predetermined crank angle in step S103. In either case, the valve opening start timing and the valve closing completion timing of the EGR valve 53 are acquired in advance by experiment, simulation, or the like. The temperature in the cylinder 2 may be detected with a sensor, and the valve opening start timing and the valve closing completion timing of the EGR valve 53 may be controlled by feedback. The initial value of the valve opening start timing of the EGR valve 53 is set to the exhaust top dead center or to be after the exhaust top dead center. In the second embodiment, the ECU 10 processes step S103, thereby functioning as a control device in the present disclosure.

In step S104, a determination as to whether or not the valve opening start timing of the EGR valve 53 is before the exhaust top dead center is performed. In step S104, a determination as to whether or not the valve opening start timing of the EGR valve 53 is already advanced to be before the exhaust top dead center is performed. When a positive determination is made in step S104, a transition is made to step S105. When a negative determination is made in step S104, a transition is made to step S106.

In step S105, the valve opening start timing of the EGR valve 53 is retarded. That is, since the temperature in the cylinder 2 is higher than or equal to the target temperature, the valve opening start timing of the EGR valve 53 is retarded. In such a case, when the valve opening start timing of the EGR valve 53 is excessively retarded, the temperature in the cylinder 2 may become lower than the target temperature again. Thus, the amount of retard in step S105 is set to be smaller than the amount of advance in step S103.

In step S106, the valve opening start timing of the EGR valve 53 is maintained. That is, since the temperature in the cylinder 2 is higher than or equal to the target temperature, and the valve opening start timing of the EGR valve 53 is after the exhaust top dead center, the temperature of EGR gas does not need to be adjusted. Thus, the current valve opening start timing of the EGR valve 53 is maintained.

According to the second embodiment described heretofore, the temperature of EGR gas can be adjusted by adjusting the valve opening start timing of the EGR valve 53. The temperature in the cylinder 2 can be set to the target temperature by adjusting the temperature of EGR gas.

### Third Embodiment

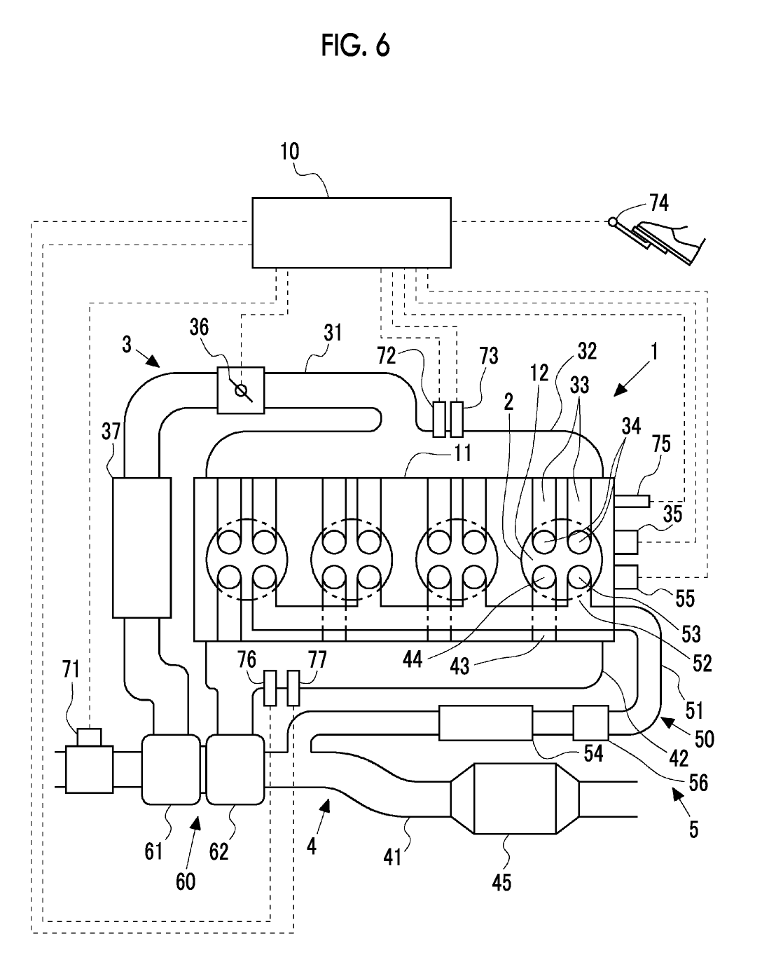

In a third embodiment, a non-return valve 56 is disposed in the middle of the EGR pipe 51. Other devices and the like are the same as the first embodiment or the second embodiment and thus, will not be described. FIG. 6 is a diagram illustrating a schematic configuration of the internal combustion engine 1 according to the third embodiment.

The non-return valve 56 is disposed in the EGR pipe 51 between the cylinder 2 and the EGR cooler 54. The non-return valve 56 is configured to allow EGR gas to pass to the cylinder 2 side from the exhaust pipe 41 side and not allow EGR gas to pass to the exhaust pipe 41 side from the cylinder 2 side.

While the non-return valve 56 can also be disposed in the EGR pipe 51 between the exhaust pipe 41 and the EGR cooler 54, disposing the non-return valve 56 in the EGR pipe 51 between the cylinder 2 and the EGR cooler 54 as illustrated in FIG. 6 can suppress high temperature EGR gas passing through the non-return valve 56. That is, when EGR gas is supplied, EGR gas of which the temperature is decreased by the EGR cooler 54 passes through the non-return valve 56 by disposing the non-return valve 56 further on the cylinder 2 side than the EGR cooler 54 in the EGR pipe 51. Thus, an increase in the temperature of the non-return valve 56 can be suppressed, and deterioration of the non-return valve 56 can be suppressed.

Disposing the non-return valve 56 can restrict the amount of burned gas that flows into the EGR passage 50 from the cylinder 2. For example, EGR gas may be supplied into the cylinder 2 by opening the EGR valve 53, and the intake valve 34 may be opened before the EGR valve 53 is closed. When both of the intake valve 34 and the EGR valve 53 are open, the pressure in the cylinder 2 becomes higher than the pressure in the EGR port 52 when the pressure of intake air is increased by a boost. Thus, fresh air may flow into the EGR port 52 from the cylinder 2. When fresh air flows into the EGR port 52, fresh air that flows into the EGR port 52 is first supplied into the cylinder 2 when the EGR valve 53 is opened in the next cycle. Thus, the concentration of EGR gas in the cylinder 2 is decreased. The amount of fresh air flowing into the EGR port 52 can be restricted by disposing the non-return valve 56. The position in which the non-return valve 56 is disposed may be acquired by experiment, simulation, or the like.

When burned gas in the exhaust stroke actively flows back to the EGR port 52 as described in the second embodiment, the non-return valve 56 may be disposed in a position where a desired amount of burned gas flows back to the EGR port 52. That is, the non-return valve 56 may be disposed in a position where the capacity of the EGR passage 50 from the EGR valve 53 to the non-return valve 56 is greater than or equal to the capacity corresponding to the amount of gas that flows through the EGR passage 50 from the cylinder 2 when the EGR valve 53 is open in the exhaust stroke. When the desired amount of burned gas that flows back to the EGR port 52 varies according to the situation, the non-return valve 56 is disposed in a position where the maximum desired amount of burned gas can flow back to the EGR port 52. In such a case as well, the position in which the non-return valve 56 is disposed may be acquired by experiment, simulation, or the like.

According to the third embodiment described heretofore, a decrease in the concentration of EGR gas can be suppressed.

What is claimed is:

1. An exhaust gas control apparatus of an internal combustion engine, the exhaust gas control apparatus comprising:
a turbocharger including a turbine in an exhaust passage of the internal combustion engine;
a post-processing device configured to control exhaust gas, the post-processing device being disposed in the exhaust passage downstream of the turbine;
an EGR passage configured to connect the exhaust passage downstream of the turbine and upstream of the post-processing device with a cylinder of the internal combustion engine; and
an EGR device including an EGR valve which is disposed in an end portion on a cylinder side of the EGR passage and opens or closes the EGR passage in the cylinder.

2. The exhaust gas control apparatus according to claim 1, further comprising:
an adjusting mechanism configured to adjust an opening and closing timing of the EGR valve; and
a control device configured to control the adjusting mechanism,
wherein when a temperature in the cylinder of the internal combustion engine is lower than a target temperature, the control device controls the adjusting mechanism such that a valve opening start timing of the EGR valve occurs in an exhaust stroke, and that a valve closing completion timing of the EGR valve occurs in an intake stroke.

3. The exhaust gas control apparatus according to claim 2, wherein when the temperature in the cylinder of the internal combustion engine is lower than the target temperature, the control device controls the adjusting mechanism such that the valve opening start timing of the EGR valve is before an exhaust top dead center, and that the valve closing completion timing of the EGR valve is after the exhaust top dead center.

4. The exhaust gas control apparatus according to claim 1, wherein the EGR device further includes, in the EGR passage, a non-return valve that allows gas to flow to the cylinder side from an exhaust passage side and does not allow gas to flow to the exhaust passage side from the cylinder side.

5. The exhaust gas control apparatus according to claim 2, wherein:
the EGR device further includes, in the EGR passage, a non-return valve that allows gas to flow to the cylinder side from an exhaust passage side and does not allow gas to flow to the exhaust passage side from the cylinder side; and
the non-return valve is provided in a position where a capacity of the EGR passage from the EGR valve to the non-return valve is greater than or equal to a capacity corresponding to an amount of gas that flows to the EGR passage from the cylinder when the EGR valve is open in the exhaust stroke.

6. The exhaust gas control apparatus according to claim 4, wherein the EGR device further includes an EGR cooler configured to cool gas, and the EGR cooler is provided in the EGR passage between the exhaust passage and the non-return valve.

7. The exhaust gas control apparatus according to claim 4, wherein the EGR device further includes an EGR cooler configured to cool gas, and the EGR cooler is provided in the EGR passage between the cylinder and the non-return valve.

8. The exhaust gas control apparatus according to claim 1, wherein the EGR device further includes an EGR cooler that cools gas, in the EGR passage.
